(19) United States
(12) Patent Application Publication
(10) Pub. No.: US 2024/0201684 A1
(43) Pub. Date: Jun. 20, 2024

(54) REMOTE INSTRUCTION SYSTEM AND STORAGE MEDIUM

(71) Applicant: TOYOTA JIDOSHA KABUSHIKI KAISHA, Toyota-shi (JP)

(72) Inventors: Yuki Suehiro, Susono-shi (JP); Rio Suda, Toyota-shi (JP)

(73) Assignee: TOYOTA JIDOSHA KABUSHIKI KAISHA, Toyota-shi (JP)

(21) Appl. No.: 18/465,372

(22) Filed: Sep. 12, 2023

(30) Foreign Application Priority Data
Dec. 19, 2022 (JP) 2022-202295

(51) Int. Cl. G05D 1/00; H04N 7/18

(52) U.S. Cl. CPC G05D 1/0022; G05D 1/0038; H04N 7/185; B60W 60/001

(57) ABSTRACT

A remote instruction system displays a surrounding environment image to a remote commander based on detection data from an external sensor of a vehicle sent, via a plurality of communication networks, from the vehicle configured to execute remote support according to a remote instruction from the remote commander. The remote instruction system includes an integrated information generation unit and a display generation unit. The display control unit selects one target area from a plurality of display areas, and displays an image representing integrated information in the selected target area.

### CROSS-REFERENCE TO RELATED APPLICATION

This application claims priority to Japanese Patent Application No. 2022-202295 filed on Dec. 19, 2022, incorporated herein by reference in its entirety.

### BACKGROUND

### 1. Technical Field

The present disclosure relates to remote instruction systems and storage media.

### 2. Description of Related Art

For example, Japanese Unexamined Patent Application Publication No. 2016-167676 (JP 2016-167676 A) describes a communication terminal device that receives, via communication, camera images captured at a plurality of locations in a teleconference, graphs communication quality data of a plurality of communications, combines each piece of the graphed data with the camera image of a corresponding one of the locations, and displays the resultant image.

### SUMMARY

In a remote instruction system in which a remote commander can perform remote support for a vehicle, a plurality of display areas is sometimes prepared for the remote commander. Display data corresponding to detection data from an external sensor of the vehicle may be displayed on these display areas. Since the display data is received via a plurality of communication networks, communication quality information of these communication networks is sometimes displayed to the remote commander. In this case, for example, in order to make it easier for the remote commander to focus on giving remote instructions, it is desired to display the communication quality information to the remote commander in a manner that is easy for the remote commander to recognize.

One aspect of the present disclosure is a remote instruction system configured to display a surrounding environment image to a remote commander based on detection data from an external sensor of a vehicle sent from the vehicle via a plurality of communication networks. The vehicle is configured to execute remote support according to a remote instruction from the remote commander. The remote instruction system includes: an integrated information generation unit configured to generate, based on communication quality information of each of the communication networks, integrated information of a plurality of pieces of the communication quality information; and a display control unit configured to acquire display data of the surrounding environment image based on the detection data received from the vehicle and display the surrounding environment image in one or more of a plurality of display areas for the remote commander. The display control unit is configured to select one target area from the display areas and display an image representing the integrated information in the selected target area.

According to the remote instruction system of the one aspect of the present disclosure, the integrated information generation unit generates the integrated information of the pieces of communication quality information. The display control unit selects one target area from the display areas and displays an image representing the integrated information in the selected target area. The remote commander can therefore recognize the integrated information by looking at the one target area. Accordingly, the communication quality information can be displayed to the remote commander in a manner that is easier for the remote commander to recognize as compared to the case where, for example, the pieces of communication quality information are displayed as they are in the display areas without being integrated.

In one embodiment, the display control unit may be configured to, in a case where part of the detection data is sent from the vehicle, select the target area from the display areas in which the surrounding environment image corresponding to the part of the detection data is displayed. In this case, the remote commander is highly likely to look at the display areas in which the surrounding environment image corresponding to the part of the detection data is displayed. Since the target area is selected from such display areas, the communication quality information can be displayed to the remote commander in a manner that is easier for the remote commander to recognize as compared to the case where, for example, the image representing the integrated information is displayed in a display area in which the surrounding environment image is not displayed.

In one embodiment, the integrated information generation unit may be configured to generate a recommended speed as the integrated information, the recommended speed being a vehicle speed of the vehicle according to the communication quality information, and the display control unit may be configured to display an image representing the recommended speed in the target area. In this case, the remote commander can recognize the recommended speed according to the communication quality information by recognizing the integrated information.

Another aspect of the present disclosure is a storage medium storing a remote instruction program configured to cause a processor to operate to display a surrounding environment image to a remote commander based on detection data from an external sensor of a vehicle sent from the vehicle via a plurality of communication networks. The vehicle is configured to execute remote support according to a remote instruction from the remote commander. The remote instruction program is configured to cause the processor to operate as an integrated information generation unit and a display control unit. The integrated information generation unit is configured to generate, based on communication quality information of each of the communication networks, integrated information of a plurality of pieces of the communication quality information. The display control unit is configured to acquire display data of the surrounding environment image based on the detection data received from the vehicle and display the surrounding environment image in one or more of a plurality of display areas for the remote commander. The remote instruction program is configured to cause the processor to operate in such a manner that the display control unit selects one target area from the display areas and displays an image representing the integrated information in the selected target area.

According to the storage medium of the another aspect of the present disclosure, the integrated information of the pieces of communication quality information is generated. One target area is selected from the display areas, and the image representing the integrated information is displayed in the selected target area. The remote commander can therefore recognize the integrated information by looking at the one target area. Accordingly, the communication quality information can be displayed to the remote commander in a manner that is easier for the remote commander to recognize as compared to the case where, for example, the pieces of communication quality information are displayed as they are in the display areas without being integrated.

According to the present disclosure, it is possible to display the communication quality information to the remote commander in a manner that is easy for the remote commander to recognize.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of a remote instruction system according to an embodiment;

FIG. 2 is a block diagram illustrating an example of a configuration of a vehicle;

FIG. 3 is a block diagram illustrating an example of a hardware configuration of a relay server;

FIG. 4 is a block diagram illustrating an example of a functional configuration of a relay server;

FIG. 5 is a block diagram illustrating an example of a hardware configuration of a remote instruction server;

FIG. 6 is a block diagram illustrating an example of a configuration of a remote instruction device;

FIG. 7 is an example of a plurality of display areas and an example of displaying an image representing integrated information to a target area;

FIG. 8A shows a first example of an image representing integrated information;

FIG. 8B shows an example of an image when communication quality has decreased in FIG. 8A;

FIG. 9 shows a second example of an image representing integrated information;

FIG. 10A shows a third example of an image representing integrated information;

FIG. 10B shows a fourth example of an image representing integrated information; and

FIG. 11 is a sequence diagram illustrating a processing example of the remote instruction system.

### DETAILED DESCRIPTION OF EMBODIMENTS

Hereinafter, embodiments of the present disclosure will be described with reference to the drawings. In the following description, the same or corresponding elements are denoted by the same reference numerals, and redundant description is omitted.

### Overview of Remote Instruction System

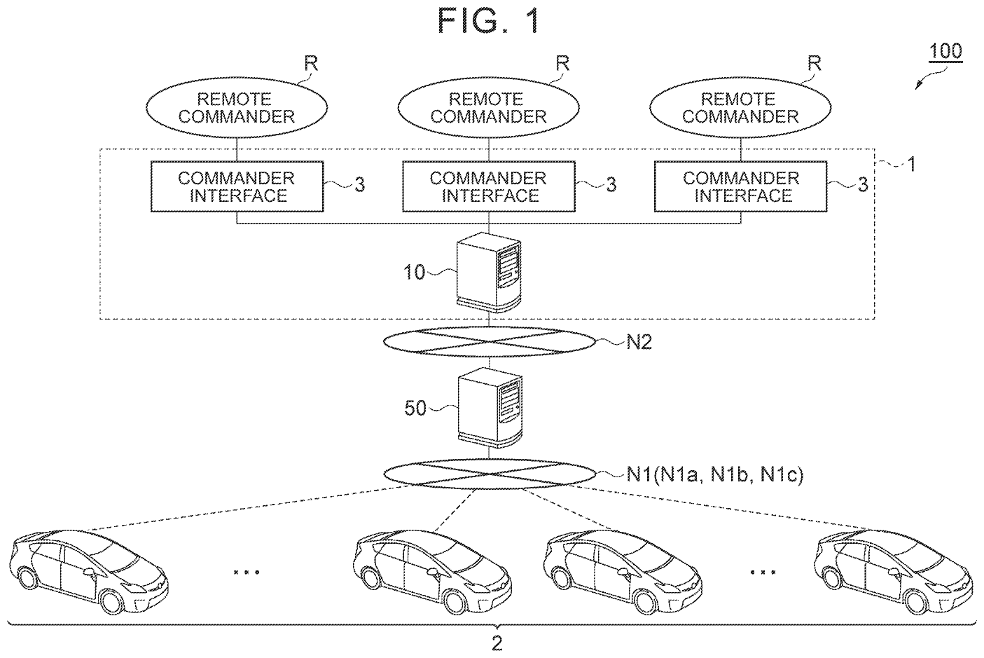

FIG. 1 is a diagram illustrating an overview of a remote instruction system according to an embodiment. As illustrated in FIG. 1, a remote instruction system 100 includes a remote instruction device 1 to which the remote commander R inputs a remote instruction, a relay server 50, and a vehicle 2. The remote instruction server 10 of the remote instruction device 1 is communicably connected to a plurality of vehicles 2 via networks N1, N2 and a relay server 50. The networks N1, N2 are radio communication networks. Various kinds of information are sent from the vehicle 2 to the remote instruction device 1.

The remote instruction system 100 executes remote support of the vehicle 2 according to remote instructions from the remote commander R. The remote instructions are instructions from the remote commander R regarding the remote support of the vehicle 2. The remote commander R is an operator who performs remote support of the vehicle 2. For example, the remote commander R is provided in a remote cockpit provided in a facility or the like remote from the vehicle 2. The number of remote commanders R may be one or two or more.

The vehicle 2 is a vehicle configured to be capable of performing remote support. The vehicle 2 may be configured to be capable of executing autonomous driving control. The number of vehicles 2 capable of communicating with the remote instruction system 100 is not particularly limited.

The remote support includes remote monitoring in which the remote commander R monitors the situation around the vehicle and the situation of the driver, remote support in which the remote commander R provides information and instructions to the driver of the vehicle, and remote driving in which the remote commander R provides instructions related to the automatic driving of the vehicle. For example, the instruction related to the automatic driving includes an instruction to advance the vehicle 2 and an instruction to stop the vehicle 2. The instruction related to the automatic driving may include an instruction to change the lane of the vehicle 2. The instruction related to the automatic driving may include an instruction to avoid an offset with respect to an obstacle in front, an instruction to overtake the preceding vehicle, an instruction to emergency evacuation, and the like.

The network N1 illustratively includes networks N1a, N1b, and N1c (a plurality of communication networks) of a plurality of communication carriers. The network N1a is a radio communication network of a first communication carrier. The network N1b is a radio communication network of a second communication carrier. The network N1c is a radio communication network of a third communication carrier. The networks N1a, N1b, and N1c may have differing communication qualities. The number of communication carriers is not limited to this example.

In the remote instruction system 100, for example, the detection data of the surrounding environment detected by the external sensor 22 of the vehicle 2 is transmitted to the relay server 50 via the networks N1a, N1b, and N1c. The relay server 50 acquires display data of the surrounding environment image from the received detection data. The surrounding environment image is a captured image of the surrounding environment of the vehicle 2 detected by the external sensor 22. The relay servers 50 generate integrated information that integrates the communication quality information of each of the networks N1a. N1b, and N1c. The display data and the integrated information of the surrounding environment images are transmitted to the remote instruction servers 10 via a network N2. The remote instruction server 10 displays an image representing the surrounding environment image and the integrated information on the remote commander R. The remote commander R inputs a remote instruction to the commander interface 3 of the remote instruction device 1 while referring to the surrounding environment image. The remote instruction device 1 sends remote instructions to the vehicles 2 through the networks N1, N2. In the vehicle 2, remote support is executed according to the remote instructions.

### Configuration of the Vehicle

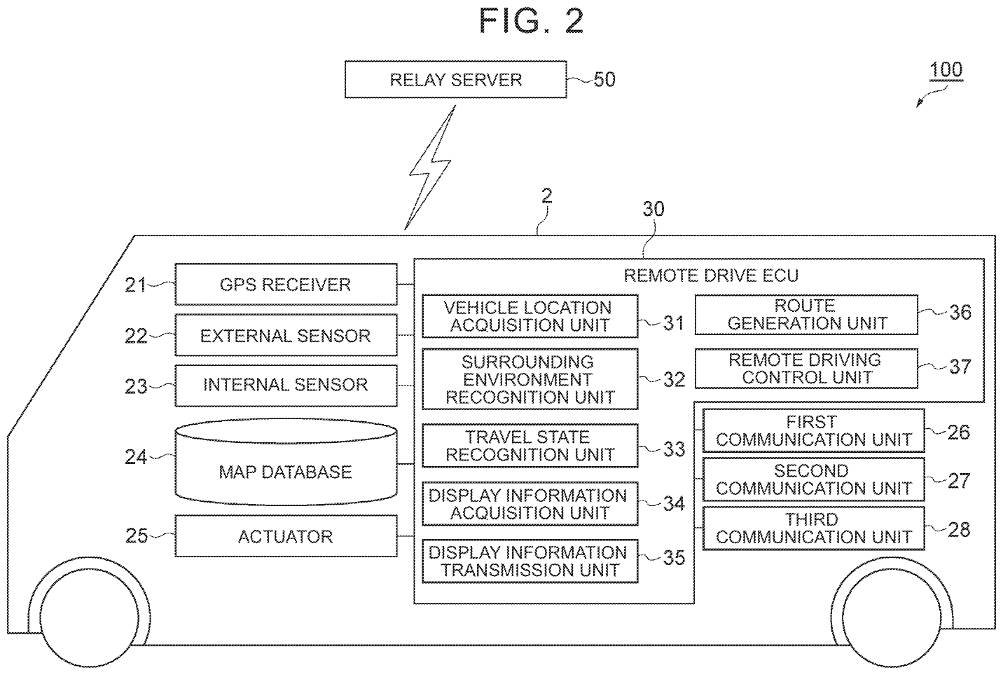

First, an example of the configuration of the vehicle 2 will be described. FIG. 2 is a block diagram illustrating an example of a configuration of a vehicle. As illustrated in FIG. 2, the vehicles 2 include, for example, a remote driving Electronic Control Unit (ECU) 30. The remote driving ECU 30 is an electronic control unit having Central Processing Unit (CPU), Read Only Memory (ROM), Random Access Memory (RAM), and the like. In the remote driving ECU 30, for example, various functions are realized by loading a program recorded in a ROM into a RAM and executing the program loaded in RAM by a CPU. The remote driving ECU 30 may include a plurality of electronic units. The remote driving ECU 30 is also referred to as, for example, Remote Driving Kit (RDK).

The remote driving ECU 30 is connected to a Global Positioning System (GPS) reception unit 21, an external sensor 22, an internal sensor 23, a map database 24, an actuator 25, a first communication unit 26, a second communication unit 27, and a third communication unit 28.

The GPS receiver 21 measures the location of the vehicle 2 (for example, the latitude and longitude of the vehicle 2) by receiving signals from three or more GPS satellites. The GPS receiver 21 sends the measured location information of the vehicles 2 to the remote driving ECU 30.

The external sensor 22 is an in-vehicle sensor that detects the surrounding environment around the vehicle 2. The external sensor 22 transmits the detected detection data to the remote driving ECU 30.

The external sensor 22 includes at least a camera. The camera is an imaging device that images the surrounding environment of the vehicle 2. The camera is provided, for example, on the rear side of the windshield of the vehicle 2 and captures an image of the front side of the vehicle. The camera may image the side and the rear of the vehicle 2.

The external sensor 22 may include a radar sensor. The radar sensor is a detection device that detects an object around the vehicle 2 using radio waves (for example, millimeter waves) or light. The radar sensor includes, for example, a radar (millimeter-wave radar) or a Light Detection and Ranging (LiDAR).

The internal sensor 23 is an in-vehicle sensor that detects a traveling state of the vehicle 2. The internal sensor 23 may include a vehicle speed sensor, an acceleration sensor, and a yaw rate sensor. Known sensors can be used as the vehicle speed sensor, the acceleration sensor, and the yaw rate sensor.

The map database 24 is a database that records map information. The map database 24 is formed in, for example, a recording device such as a Hard Disk Drive (HDD) mounted on the vehicle 2. The map information includes location information of a road, information of a road shape (for example, curvature information), location information of an intersection and a branch point, and the like.

The actuator 25 is a device used for driving control of the vehicles 2, and operates in accordance with a control signal from a remote driving ECU 30. The actuator 25 includes at least a drive actuator, a brake actuator, and a steering actuator. The drive actuator is provided in, for example, an engine or a motor as a power source, and controls the driving force of the vehicle 2. The brake actuator is provided in, for example, a hydraulic brake system, and controls braking force applied to wheels of the vehicle 2. The steering actuator is, for example, an assist motor of an electric power steering system, and controls the steering torque of the vehicle 2.

The first communication unit 26, the second communication unit 27, and the third communication unit 28 are communication devices that control wireless communication with the outside of the vehicle 2. The first communication unit 26 sends and receives various types of information to and from the relay server 50 via the network N1a of the first communication carrier. The second communication unit 27 sends and receives various types of information to and from the relay server 50 via the network N1b of the second communication carrier. The third communication unit 28 sends and receives various types of information to and from the relay server 50 via the network N1c of the third communication carrier.

Next, an exemplary functional configuration of the remote driving ECU 30 will be described. The remote driving ECU 30 includes a vehicle position acquisition unit 31, a surrounding environment recognition unit 32, a traveling condition recognition unit 33, a display information acquisition unit 34, a display information transmission unit 35, a route generation unit 36, and a remote driving control unit 37.

The vehicle position acquisition unit 31 acquires the position information (position on the map) of the vehicle 2 based on the position information of the GPS reception unit 21 and the map information of the map database 24 or by Simultaneous Localization and Mapping (SLAM) technique.

The surrounding environment recognition unit 32 recognizes the surrounding environment of the vehicle 2 based on the detection data of the external sensor 22. The surrounding environment may include information used for automatic driving, such as a relative position, a relative speed, and a moving direction of the surrounding object with respect to the vehicle 2.

The traveling condition recognition unit 33 recognizes the traveling state of the vehicle 2 based on the detection result of the internal sensor 23. The traveling state includes the vehicle speed of the vehicle 2, the acceleration of the vehicle 2, and the yaw rate of the vehicle 2 (the direction of the vehicle 2).

The display information acquisition unit 34 acquires display information for display to the remote commander R based on the detection data of the external sensor 22 or the calculation result of the remote driving ECU 30. The display information may include information on a position of the vehicle 2, a destination, a route of the vehicle 2 generated by the route generation unit 36, which will be described later, and a traveling state (e.g., vehicle speed). The information for displaying may be information outside the range of the operating range (operation design domain (ODD)) of the autonomous driving system. ODD is the extent to which the autonomous driving system operates as designed.

The display information includes vehicle transmission image data transmitted to the remote commander R to display the surrounding environment image. The vehicle transmission image data is acquired, for example, based on an image (detection data) captured by a camera of the vehicle 2. The vehicle transmission image data may include, for example, an image of a scene in front of the vehicle 2, an overhead image of the vehicle 2, and the like. The vehicle transmission image data may include detection data of a lateral or rear image of the vehicle 2 captured by the camera of the vehicle 2. The display information acquisition unit 34 acquires the vehicle transmission image data based on the captured image of the camera of the external sensor 22.

The vehicle transmission image data may be part of the detection data of the external sensor 22. The display information acquisition unit 34 may set a range of information to be transmitted to the relay server 50 among the detection data of the external sensor 22. For example, the display information acquisition unit 34 may set a range of data to be transmitted to the relay server 50 (the remote instruction server 10) among the detection data of the external sensor 22 based on the surrounding environment recognized by the surrounding environment recognition unit 32, the map information of the map database 24, and the route of the vehicle 2. Here, the route is a route before the route corresponding to the remote instruction is generated.

The display information acquisition unit 34 may determine a sensor that includes detection data in the vehicle transmission image data among the plurality of sensors included in the external sensor 22. For example, the display information acquisition unit 34 may not include, in the vehicle transmission image data, detection data of a sensor that does not include, in the detection range, a region around the vehicle 2 to be confirmed by the remote commander R based on the recognized surrounding environment.

The display information acquisition unit 34 may extract a portion to be transmitted to the relay server 50 in the detection data of the external sensor 22 based on the map information and the route. Here, extracting a portion to be transmitted to the relay server 50 in the detection data of the external sensor 22 is, for example, to cut out an unnecessary portion of the detection data and leave only a necessary portion (a portion to be transmitted), the display information acquisition unit 34 can be used as a portion to cut out and send part of the captured image of the camera of the external sensor 22.

The display information transmission unit 35 sends the display information acquired by the display information acquisition unit 34 to the relay server 50. The display information transmission unit 35 sends the vehicle-transmitted image data to the relay server 50 in parallel via the networks N1a, N1b, and N1c using the first communication unit 26, the second communication unit 27, and the third communication unit 28, respectively.

The route generation unit 36 generates a route (trajectory) used for automated driving of the vehicles 2. The route generation unit 36 generates a route for automatic driving on the basis of the target route, the map information, the position information of the vehicle 2, the surrounding environment of the vehicle 2, and the traveling state of the vehicle 2, which are set in advance. The route corresponds to a travel plan for automatic driving. As the route generation method in the route generation unit 36, a well-known method relating to automatic driving can be adopted. The same applies to the contents of the course.

The remote driving control unit 37 executes remote support, remote driving, or automatic driving of the vehicle 2. The remote driving control unit 37 may provide information, instructions, and the like to the driver of the vehicle 2 in response to a remote instruction from the remote commander R. The remote driving control unit 37 may execute the automatic driving of the vehicle 2 based on the surrounding environment of the vehicle 2, the traveling state of the vehicle 2, and the route generated by the route generation unit 36. The remote driving control unit 37 may give an instruction related to the automatic driving of the vehicle 2 in response to a remote instruction from the remote commander R. The remote driving control unit 37 can perform remote driving and automatic driving of the vehicle 2 by transmitting a control signal to the actuator 25.

### Configuration of the Relay Server

The relay server 50 relays transmission and reception of data between the vehicle 2 and the remote instruction device 1. As an example of the hardware configuration of the relay server 50, a cloud server can be used. As an example of the functional configuration (software configuration) of the relay server 50, a remote instruction program according to the present disclosure can be used.

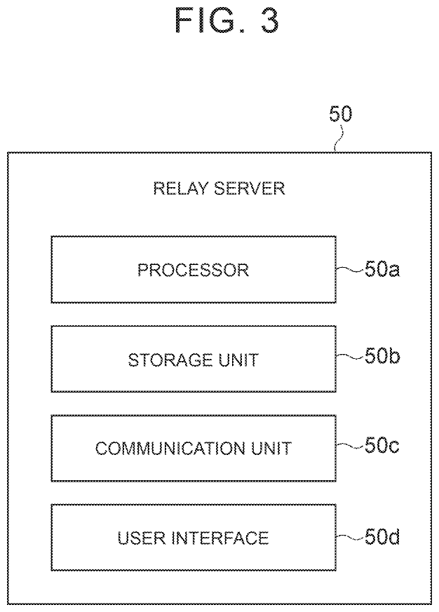

FIG. 3 is a block diagram illustrating an example of a hardware configuration of a relay server. As illustrated in FIG. 3, the relay servers 50 are configured as a typical computer including a processor 50a, a storage unit 50b, a communication unit 50c, and a user interface 50d. In this case, the user means a user (administrator or the like) of the relay server 50.

The processor 50a operates various operating systems to control the relay servers 50. The processor 50a is an arithmetic unit such as a CPU including a control device, an arithmetic device, a register, and the like. The processor 50a controls the storage unit 50b, the communication unit 50c, and the user interface 50d. The storage unit 50b includes at least one of a memory and a storage. The memories are recording media such as ROM, RAM. The storage is a recording medium such as a HDD.

The communication unit 50c is a communication device for performing communication via the networks N1, N2. Network devices, network controllers, network cards and the like may be used for the communication unit 50c. The user interface 50d is an input/output unit of the relay servers 50 for a user such as an administrator. The user interface 50d includes a display, an output device such as a speaker, and an input device such as a touch panel.

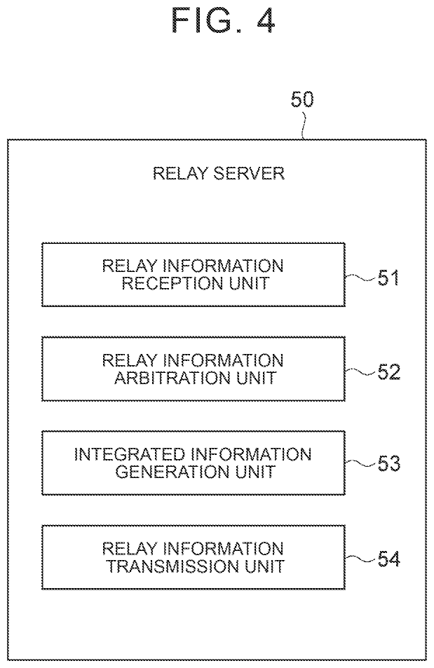

Next, the functional configuration of the relay server 50 will be described. FIG. 4 is a block diagram illustrating an example of a functional configuration of a relay server. As illustrated in FIG. 4, the relay server 50 includes a relay information reception unit 51, a relay information arbitration unit 52, an integrated information generation unit 53, and a relay information transmission unit 54.

The relay information reception unit 51 receives various kinds of information and various kinds of data transmitted from the vehicle 2 or the remote instruction device 1. The relay information reception unit 51 receives the vehicle transmission image data transmitted from the vehicle 2. For example, the relay information reception unit 51 receives vehicle-transmitted-image data transmitted in parallel via the networks N1a, N1b, and N1c by the display-use information transmission unit 35.

The relay information reception unit 51 acquires communication quality information of each of the networks N1a, N1b, and N1c. The communication quality information includes information related to communication qualities of communication using the first communication unit 26 and the network N1a as a communication path, communication using the second communication unit 27 and the network N1b as a communication path, and communication using the third communication unit 28 and the network N1c as a communication path. The communication quality information includes, for example, an estimated value of the frame rate, the bit rate, and the number of packets, an actual value of the frame rate, the bit rate, and the number of packets, and a radio wave intensity at the position of the vehicle 2 with respect to the received vehicle transmission image data. The relay information reception unit 51 can acquire the communication quality information, for example, based on the measured value of the transmission/reception amount of each data accompanying the communication or the information provided from each communication carrier.

The relay-information reception unit 51 acquires, for example, the estimated number of packets of each of the networks N1a, N1b, and N1c. The estimated number of packets is the total number of packets when it is assumed that all data can be relayed without loss or the like in communication via each of the networks N1a, N1b, and N1c. The estimated number of packets corresponds to, for example, the number of packets of the data amount of the vehicle transmission image data. Therefore, the number of packets obtained by subtracting the number of constructed packets from the number of assumed packets corresponds to packet loss.

The relay-information reception unit 51 acquires, for example, the respective radio wave strengths of the networks N1a. N1b, and N1c from the respective communication carriers.

The relay information reception unit 51 may receive remote instruction data of the remote commander R transmitted from the remote instruction device 1. The relay-information reception unit 51 receives, for example, remote instruction data of the remote commander R transmitted via the network N2 by the remote instruction transmission unit 14 described later.

The relay information arbitration unit 52 arbitrates the vehicle transmission image data transmitted in parallel from the vehicle 2. For example, the relay-information arbitration unit 52 deletes duplicate packets, rearranges packet orders, and the like for three pieces of vehicle-transmitted image data received in parallel via the networks N1a, N1b, and N1c, and generates one piece of arbitration image data representing a surrounding environment image. The arbitration image data is an example of display data of a surrounding environment image. That is, the relay information arbitration unit 52 functions as part of the display control unit that acquires the display data of the surrounding environment image based on the detection data received from the vehicle 2.

The relay-information arbitration unit 52 acquires, for example, the number of constructed packets of each of the networks N1a, N1b, and N1c. The number of constructed packets is the total number of packets employed in generating the arbitration image data. The number of constructed packets is counted for each network N1a, N1b, N1c.

The integrated information generation unit 53 generates integrated information obtained by integrating a plurality of pieces of communication quality information based on the pieces of communication quality information of the networks N1a, N1b, and N1c. The integrated information is an index that represents a control state (multipath control state) using a plurality of communication paths of the remote instruction system 100 by integrating a plurality of pieces of communication quality information. For example, the integrated information generation unit 53 generates, as the integrated information, the average number of constructed packets which is the average number of constructed packets of the vehicle-transmitted-image-data received through each of the networks N1a, N1b, and N1c. The integrated information generation unit 53 may generate, as the integrated information, an average value of the actual values of the frame rates of the vehicle-transmitted image data received through each of the networks N1a, N1b, and N1c. The integrated information generation unit 53 may generate, as the integrated information, an average value of the actual values of the bit rates of the vehicle-transmitted image data received through each of the networks N1a, N1b, and N1c.

The integrated information generation unit 53 may acquire the number of times of adoption of the packet adopted when the relay information arbitration unit 52 generates the arbitration image data. The number of recruitment times is acquired for each network N1a, N1b, N1c used to transmit from the vehicles 2. The integrated information generation unit 53 may calculate a contribution degree of each of the first communication carrier, the second communication carrier, and the third communication carrier on the basis of the number of adoptions and the average number of constructed packets of each of the first communication carrier, the second communication carrier, and the third communication carrier.

The integrated information generation unit 53 may generate, as the integrated information, a recommended speed that is the vehicle speed of the vehicle 2 according to the communication quality information. The recommended speed is a reference value of the vehicle speed of the vehicle 2 when the vehicle 2 is remotely supported. When the vehicle speed of the vehicle 2 is equal to or lower than the recommended speed, the image quality of the surrounding environment image affected by the communication quality is sufficient for the remote commander R to remotely support the image quality under the communication quality. The remote commander R can refer to the recommended speed when sending remote instructions to the vehicle 2. The recommended speed may be obtained according to the actual value of the frame rate and the bit rate, for example. The recommended speed may be a lower speed as the actual value of the frame rate is smaller. The recommended speed may be the lower the actual value of the bit rate.

The relay information transmission unit 54 transmits various kinds of information and various kinds of data of the result calculated by the relay server 50 to the vehicle 2 or the remote instruction device 1. The relay information transmission unit 54 transmits, for example, the arbitration image data as display data of the surrounding environment image to the remote instruction device 1. The relay-information transmission unit 54 transmits, as the integrated information, for example, the number of constructed packets, the number of averaged constructed packets, the number of assumed packets, the recommended rate, and the radio wave strength of each of the networks N1a, N1b, and N1c to the remote instruction device 1. The relay information transmission unit 54 transmits the remote instruction data of the remote commander R received from the remote instruction device 1 to the vehicle 2.

### Configuration of Remote Instruction Device

A configuration of the remote instruction device 1 will be described with reference to the drawings. The remote instruction device 1 includes a remote instruction server 10 and a commander interface 3.

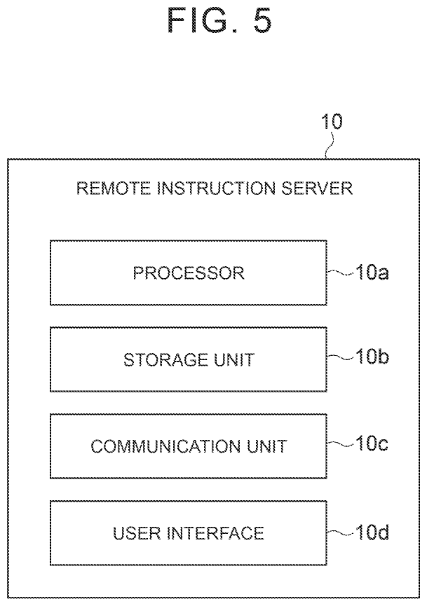

First, the hardware configuration of the remote instruction server 10 will be described. FIG. 5 is a block diagram illustrating an example of a hardware configuration of a remote instruction server. As illustrated in FIG. 5, the remote instruction server 10 is configured as a typical computer including a processor 10a, a storage unit 10b, a communication unit 10c, and a user interface 10d. In this case, the user means a user (administrator or the like) of the remote instruction server 10. The processor 10a, the storage unit 10b, the communication unit 10c, and the user interface 10d may have, for example, the same hardware configuration as the processor 50a, the storage unit 50b, the communication unit 50c, and the user interface 50d. The processor 10a operates various operating systems to control the remote instruction servers 10. The communication unit 10c is a communication device for performing communication via the network N2. Note that the remote instruction server 10 is not necessarily provided in a facility or the like having a remote cockpit, and may be mounted on a moving body such as a vehicle.

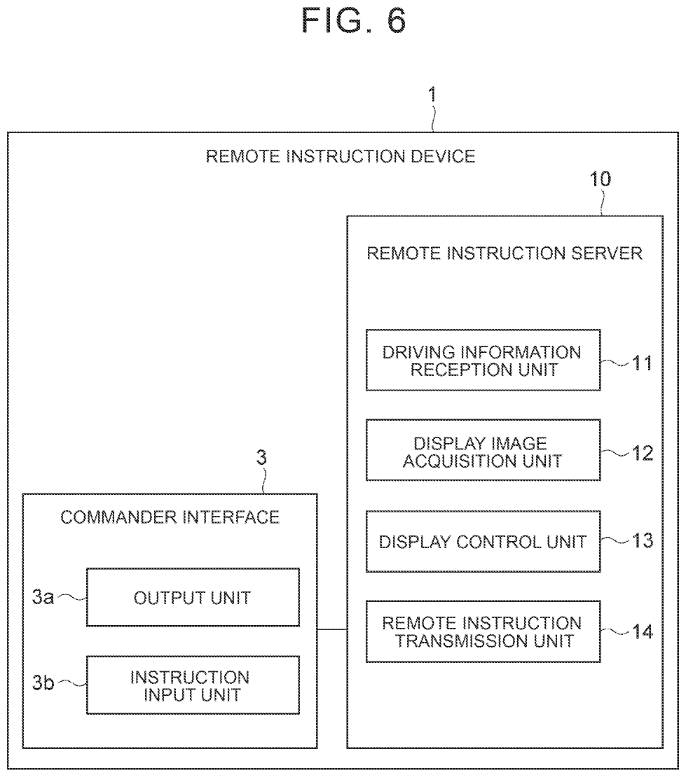

FIG. 6 is a block diagram illustrating an example of a configuration of a remote instruction device. As shown in FIG. 6, the commander interface 3 is an input/output unit of the remote instruction device 1 for the remote commander R. The commander interface 3 includes an output unit 3a and an instruction input unit 3b.

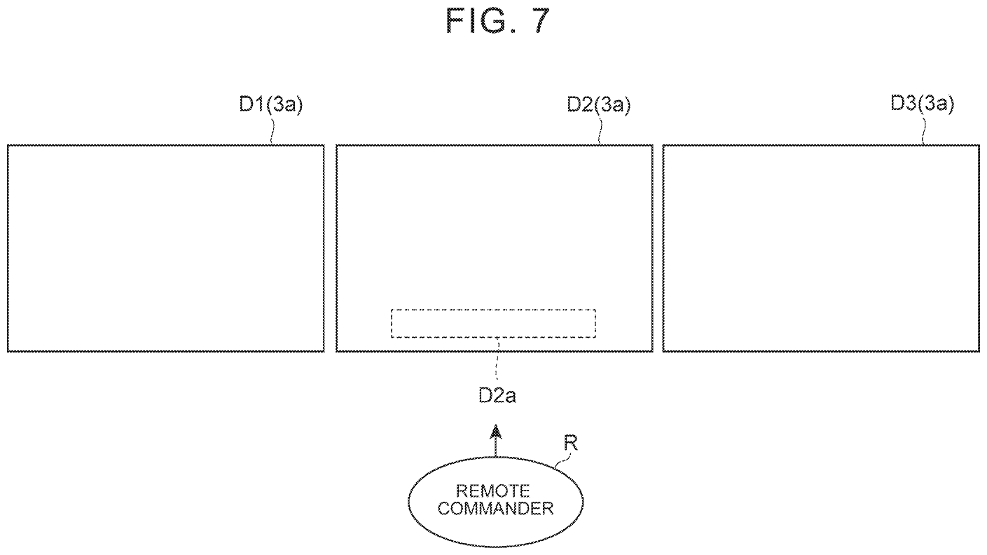

The output unit 3a is a device that outputs information used for remote instruction of the vehicle 2 to the remote commander R. The output unit 3a includes a plurality of displays (display areas) D1, D2, and D3 for outputting images (see FIG. 7). The displays D1, D2, and D3 are a plurality of display areas for the remote commander R. The output unit 3a may include a speaker that outputs sound. The speaker may be, for example, a headset speaker worn on the head of the remote commander R. The output unit 3a may provide information to the remote commander R by vibration using, for example, a vibration actuator provided in the seat.

A surrounding environment image acquired from the vehicle-transmitted image data is displayed on the displays D1, D2, and D3. Images of a scene in front of the vehicle 2 captured by the camera of the vehicle 2 are displayed on the displays D1, D2, and D3. Images of the side or the rear of the vehicle 2 captured by the camera of the vehicle 2 may be displayed on the displays D1, D2, and D3. As will be described later, the displays D1, D2, and D3 may display an image representing the integrated information in a manner superimposed on the surrounding environment image.

The instruction input unit 3b is a device to which a remote instruction is input by the remote commander R. The instruction input unit 3b may include an operation device having a known configuration such as an operation lever, an operation pedal, and an operation button.

Next, a functional configuration of the remote instruction server 10 will be described. As illustrated in FIG. 6, the remote instruction server 10 includes an operation information reception unit 11, a display image acquisition unit 12, a display control unit 13, and a remote instruction transmission unit 14.

The operation information reception unit 11 receives driving information for the remote commander R to remotely support the vehicle 2. The driving information includes display data and integrated information of the surrounding environment image. The driving information may include information related to automatic driving of the vehicle 2, such as a course when the vehicle 2 travels in automatic driving.

The operation information reception unit 11 receives, for example, the arbitration image data transmitted from the relay information transmission unit 54 as the display data of the surrounding environment image. The operation information reception unit 11 receives the integrated information transmitted from the relay information transmission unit 54. The operation information reception unit 11 receives, as the integrated information, for example, the number of constructed packets, the number of averaged constructed packets, the number of assumed packets, the recommended rate, and the radio wave strength of each of the networks N1a, N1b, and N1c.

The display image acquisition unit 12 acquires an image to be displayed on the remote commander R based on the received driving information. The display image acquisition unit 12 acquires, for example, a surrounding environment image of the received arbitration image data as an image to be displayed on the remote commander R. The display image acquisition unit 12 acquires an image representing the integrated information, for example, based on the received integrated information. The image representing the integrated information will be described in detail later.

The display control unit 13 controls display of images on a plurality of displays D1, D2, and D3 for the remote commander R. The display control unit 13 causes one or more of the displays D1, D2, and D3 for the remote commander R to display a surrounding environment image.

FIG. 7 illustrates an example of a plurality of display areas and an example of displaying an image representing integrated information to a target area. As illustrated in FIG. 7, for example, when all of the vehicle transmission image data (detection data) of the vehicle 2 is transmitted from the vehicle 2, the display control unit 13 causes all of the displays D1, D2, and D3 for the remote commander R to display the surrounding environment images corresponding to all of the vehicle transmission image data.

The display control unit 13 selects one target area from the displays D1, D2, and D3, and displays images representing the integrated information in the selected target area. The target area is a display area for displaying an image representing the integrated information. The display control unit 13 selects, as the target area, a display area in which the integrated information (communication quality information) can be displayed in a manner that is easily recognized by the remote commander R from the displays D1, D2, and D3. In the example of FIG. 7, the target area may be, for example, a display D2 located in front of the remote commander R among a plurality of displays D1, D2, and D3. When the line of sight of the remote commander R faces any of the displays D1, D3, for example, a right-left turn or a lane change at an intersection of the vehicles 2, the display control unit 13 may select any of the displays D1, D3 as the target area in accordance with the content of the remote support.

The display control unit 13 causes an image representing the integrated information to be displayed in the selected target area. In FIG. 7, the display control unit 13 causes the partial area D2a of the display D2 that is the selected target area to display images representing the integrated information.

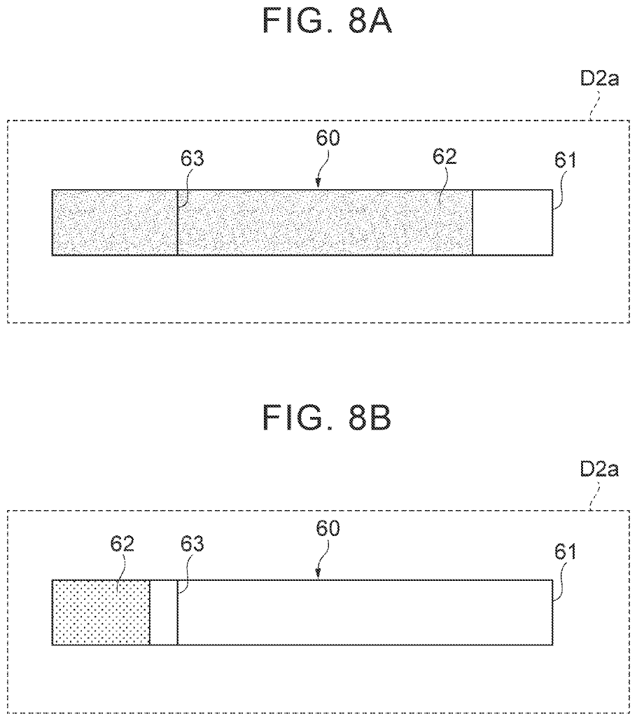

A specific example of an image representing the integrated information will be described. FIG. 8A shows a first example of an image representing the integrated information. In FIG. 8A, a bar graph 60 extending in the longitudinal direction along the long side of the display D2 is drawn in the partial area D2a. As shown in FIG. 8A, the bar graph 60 includes an outer frame 61, a value-display 62, and threshold values 63. The outer frame 61 has a rectangular shape along the longitudinal direction. The value display 62 has a rectangular shape along the longitudinal direction, and is drawn in the outer frame 61 in a left-aligned manner toward the plane of the drawing. The value display 62 has, for example, a color or a pattern different from that in the outer frame 61. In the outer frame 61, a line segment representing the threshold value 63 is drawn so as to extend in a lateral direction intersecting the longitudinal direction.

The outer frame 61, the value display 62, and the threshold value 63 are, for example, images representing the number of packets whose origin is the left end portion toward the drawing in the outer frame 61. The position in the outer frame 61, the position at the right end of the value display 62, and the position of the threshold value 63 represent the larger number of packets as they are positioned on the right side toward the paper surface. The dimension of the outer frame 61 in the longitudinal direction represents the number of assumed packets. The longitudinal dimension of the value display 62 represents the average number of constructed packets.

The threshold value 63 is a threshold value for generally evaluating a control state (multi-path control state) using a plurality of communication paths of the remote instruction system 100 as the remote instruction system 100. The threshold value 63 is set, for example, with respect to the average number of constructed packets represented by the value display 62. The threshold value 63 may be a predetermined value set in advance or may be a variable value.

As shown in FIG. 8A, when the mean number of constructed packets represented by the value display 62 is equal to or greater than the threshold value 63, the remote commander R who has visually recognized the integrated information can recognize that the control state (multi-path control state) using the plurality of communication paths of the remote instruction system 100 is a normal control state. FIG. 8B illustrates an example of an image in which communication quality is degraded in FIG. 8A. As shown in FIG. 8B, when the average number of constructed packets represented by the value display 62 is less than the threshold value 63, the remote commander R who has visually recognized the integrated information can recognize that the control state (the control state of the multipath) using the plurality of communication paths of the remote instruction system 100 is not the normal control state.

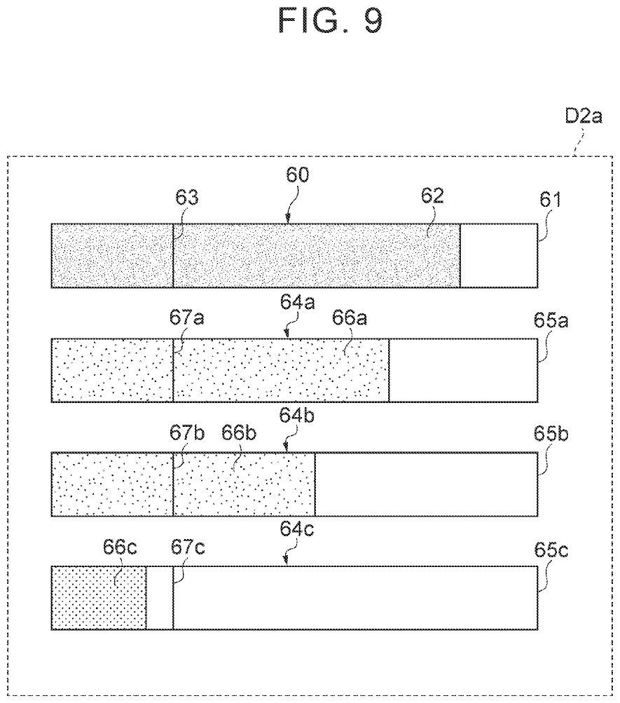

FIG. 9 shows a second example of an image representing the integrated information. In the partial area D2a of FIG. 9, in addition to the bar graph 60, a plurality of bar graphs 64a, 64b, and 64c extending in the longitudinal direction along the long side of the display D2 are drawn. The bar graphs 64a, 64b, and 64c represent the communication quality information of the networks N1a, N1b, and N1c without averaging.

The longitudinal dimension of the outer frame 65a of the bar graph 64a represents the estimated number of packets in the communication path of the first communication unit 26 and the network N1a. The longitudinal dimension of the bar graph 64a readout 66a represents the number of received packets in the communication path of the first communication unit 26 and the network N1a. The longitudinal dimension of the outer frame 65b of the bar graph 64b represents the estimated number of packets in the communication path of the second communication unit 27 and the network N1b. The longitudinal dimension of the bar graph 64b readout 66b represents the number of received packets in the communication path of the second communication unit 27 and the network N1b. The longitudinal dimension of the outer frame 65c of the bar graph 64c represents the estimated number of packets in the communication path of the third communication unit 28 and the network N1c. The longitudinal dimension of the bar graph 64c readout 66c represents the number of received packets in the communication path of the third communication unit 28 and the network N1c. In the bar graphs 64a, 64b, and 64c, for example, the estimated number of packets corresponds to the size of the vehicle transmission image data transmitted from the vehicle 2, and the number of received packets corresponds to the size of the vehicle transmission image data received by the relay servers 50. The thresholds 67a, 67b, and 67c are thresholds for individually evaluating the communication quality information of each of the networks N1a, N1b, and N1c. The thresholds 67a, 67b, and 67c are set for the number of received packets represented by the value displays 66a, 66b, and 66c, for example.

That is, the display control unit 13 may cause the display D2 (target area) to display the non-integrated image representing the communication quality information of each of the plurality of communication networks without integrating the communication quality information together with the image representing the integrated information. In the exemplary embodiment of FIG. 9, the bar graphs 64a, 64b, and 64c are unified images representing communication quality information of each of the networks N1a, N1b, and N1c without being unified. Since the bar graph 60 representing the integrated information and the bar graphs 64a, 64b, and 64c are written in parallel, not only the remote commander R can easily recognize the control state of the remote instruction system 100, but also the developer or the maintenance person of the remote instruction system 100 can confirm the communication state of each of the networks N1a, N1b, and N1c and the communication terminal states of the first communication unit 26, the second communication unit 27, and the third communication unit 28.

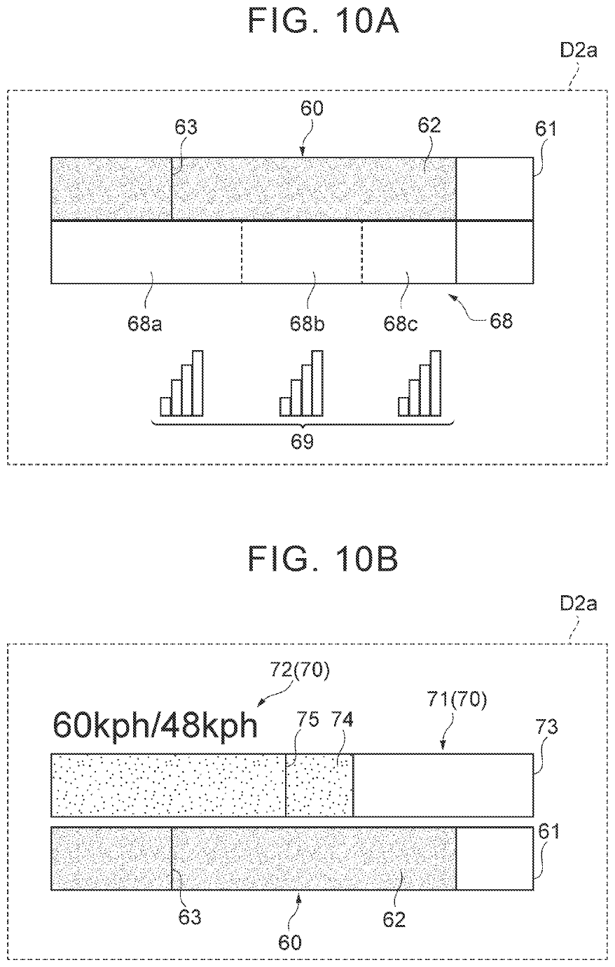

FIG. 10A shows a third example of images representing the integrated information. In addition to the bar graph 60, a carrier display 68 extending in the longitudinal direction along the long side of the display D2 is drawn on the partial area D2a in FIG. 10A. The carrier display 68 is drawn, for example, side by side with the value display 62 of the bar graph 60. The carrier display 68 is a display indicating a breakdown (contribution degree) of each communication carrier in the average number of constructed packets represented by the value display 62 of the bar graph 60 arranged upward toward the paper surface. The carrier display 68 may be, for example, a chart in which the contribution degree 68a of the first communication carrier, the contribution degree 68b of the second communication carrier, and the contribution degree 68c of the third communication carrier in the averaged number of constructed packets are stacked on the basis of the calculation result of the integrated information generation unit 53. That is, the display control unit 13 may cause the display D2 (target area) to display the carrier display 68, which is an image representing the degree of contribution of the plurality of communication carriers in the integrated information, together with the image representing the integrated information for the plurality of communication carriers providing the plurality of communication networks.

A radio wave status display 69 may be drawn in the partial area D2a in FIG. 10A. The radio wave status display 69 is an image representing the radio wave intensity at the position of the vehicle 2 of each communication carrier. For example, the radio wave status display 69 is drawn on the carrier display 68 side by side on the lower side toward the paper surface. The radio wave status display 69 may represent the radio wave intensity using, for example, a known pictogram. When the radio wave status display 69 is rendered, for example, when the display of the surrounding environment images is fixed or the display is not displayed due to the communication interruption in any of the plurality of displays D1, D2, and D3, it is possible to confirm whether the vehicle 2 is located at a point (a point outside the service area) where the radio wave intensity is insufficient prior to the occurrence of the non-display due to the fixing of the display or the communication interruption. Note that in FIG. 10A, the radio wave status display 69 may be omitted.

FIG. 10B shows a fourth example of an image representing the integrated information. In addition to the bar graph 60, a recommended speed display 70 extending in the longitudinal direction along the long side of the display D2 is drawn in the partial area D2a in FIG. 10B. The recommended speed display 70 is drawn, for example, side by side with the bar graph 60. The recommended speed display 70 includes a recommended speed bar graph 71 drawn in a similar outline to the bar graph 60 arranged downward toward the paper surface, and a recommended speed value 72 arranged in the recommended speed bar graph 71. That is, the display control unit 13 causes the display D2 (target area) to display the recommended speed display 70, which is an image representing the recommended speed.

The longitudinal dimension of the outer frame 73 of the recommended speed bar graph 71 represents the maximum value of the vehicle speed scale of the value display 74. The maximum value of the vehicle speed scale may be a predetermined fixed value, or may be variable in accordance with the vehicle speed recognized by the vehicle 2 or the recommended speed. The longitudinal dimension of the value display 74 in the recommended speed bar graph 71 represents the vehicle speed recognized by the vehicle 2. The threshold value 75 is a threshold value of the vehicle speed of the vehicle 2 representing the recommended speed according to the communication quality information. The threshold value 75 is set based on, for example, the calculation result of the integrated information generation unit 53.

The recommended speed value 72 is a numerical image representing the vehicle speed recognized by the vehicle 2 and the recommended speed. In FIG. 10B, the state where the vehicle speed recognized by the vehicle 2 is the hour speed 60 km and the recommended speed is the hour speed 48 km is illustrated. In this instance, the recommended speed value 72 may be displayed as “60 kph/48 kph”, for example.

In addition to the displays of FIGS. 7 to 10 described above, the display control unit 13 may provide various types of information regarding remote support to the remote commander R.

The remote instruction transmission unit 14 transmits various kinds of information and data related to the remote instruction from the remote commander R to the relay server 50. For example, when the remote commander R inputs a remote instruction to the instruction input unit 3b of the commander interface 3, the remote instruction transmission unit 14 transmits the input remote instruction to the vehicle 2.

### Process of Remote Instruction System 100

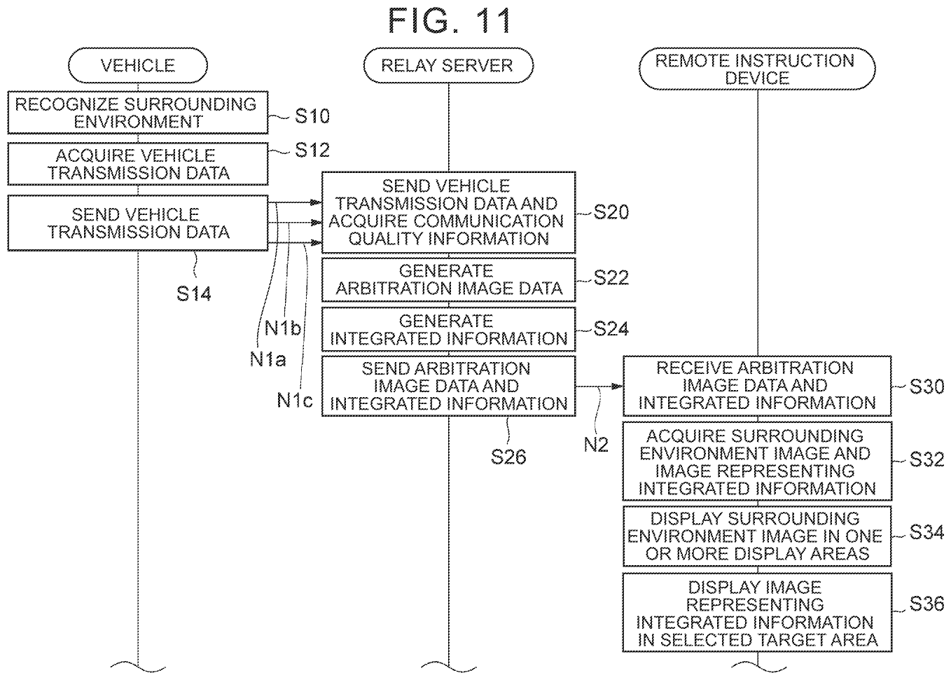

Next, an example of processing (remote instruction program) of the remote instruction system 100 will be described with reference to the flowchart of FIG. 11. FIG. 11 is a sequence diagram illustrating a processing example of the remote instruction system. The processing illustrated in FIG. 11 is executed, for example, during the operation of the vehicle 2.

As illustrated in FIG. 11, in the remote instruction system 100, the remote driving ECU 30 of the vehicle 2 recognizes the surrounding environment of the vehicle 2 by the surrounding environment recognition unit 32 in S10. The surrounding environment recognition unit 32 recognizes the surrounding environment of the vehicle 2, for example, based on the detection data of the external sensor 22.

In S12, the remote driving ECU 30 of the vehicle 2 acquires the vehicle transmitted images by the display-information acquisition unit 34. The display information acquisition unit 34 acquires the vehicle transmission image data based on the captured image of the camera of the external sensor 22.

In S14, the remote driving ECU 30 of the vehicle 2 transmits the vehicle transmission images by the display-information transmission unit 35. For example, the display-information transmission unit 35 transmits the vehicle-transmitted image-data to the relay servers 50 in parallel via the networks N1a, N1b, and N1c using the first communication unit 26, the second communication unit 27, and the third communication unit 28, respectively.

In S20, the relay servers 50 receive vehicle-transmitted image-data and acquire communication quality information by the relay information reception unit 51. For example, the relay information reception unit 51 receives the vehicle transmitted images transmitted from the vehicle 2 in parallel via the networks N1a, N1b, and N1c. The relay information reception unit 51 acquires communication quality information, for example, based on a measurement value of the transmission/reception amount of each data accompanying communication or information provided from each communication carrier.

In S22, the relay servers 50 generate arbitration images by the relay-information arbitration unit 52. For example, the relay-information arbitration unit 52 deletes duplicate packets, rearranges packet orders, and the like for three pieces of vehicle-transmitted image data received in parallel via the networks N1a, N1b, and N1c, and generates one piece of arbitration image data representing a surrounding environment image. The relay-information arbitration unit 52 acquires, for example, the number of constructed packets of each of the network N1a, N1b, N1c.

In S24, the relay servers 50 generate integrated information by the integrated information generation unit 53. For example, the integrated information generation unit 53 generates integrated information obtained by integrating a plurality of pieces of communication quality information on the basis of the respective pieces of communication quality information of the networks N1a, N1b, and N1c. For example, the integrated information generation unit 53 generates the average number of constructed packets, which is the average number of constructed packets of the networks N1a, N1b, and N1c, as the integrated information. The integrated information generation unit 53 may generate, as the integrated information, a recommended speed that is the vehicle speed of the vehicle 2 according to the communication quality information.

In S26, the relay servers 50 transmit the arbitration image data and the integrated information by the relay information transmission unit 54. The relay information transmission unit 54 transmits, for example, the arbitration image data as display data of the surrounding environment image to the remote instruction device 1. The relay-information transmission unit 54 transmits, as the integrated information, for example, the number of constructed packets, the number of averaged constructed packets, the number of assumed packets, the recommended rate, and the radio wave strength of each of the networks N1a, N1b, N1c to the remote instruction device 1.

The remote instruction server 10 of the remote instruction device 1 receives the arbitration image data and the integrated information by the operation information reception unit 11 in S30. The operation information reception unit 11 receives, for example, driving information including arbitration image data and integrated information as display data of a surrounding environment image.

In S32, the remote instruction server 10 of the remote instruction device 1 causes the display image acquisition unit 12 to acquire the surrounding environment image and the image representing the integrated information. The display image acquisition unit 12 acquires, for example, a surrounding environment image of the received arbitration image data. The display image acquisition unit 12 acquires an image representing the integrated information, for example, based on the received integrated information.

In S34, the remote instruction server 10 of the remote instruction device 1 causes the display control unit 13 to display surrounding environment images in one or more display areas. For example, the display control unit 13 causes all of the displays D1, D2, and D3 for the remote commander R to display surrounding environment images.

In S36, the remote instruction server 10 of the remote instruction device 1 causes the display control unit 13 to display images representing the integrated information in the selected target area. For example, the display control unit 13 selects one target area (e.g., display D2) from the displays D1, D2, and D3. The display control unit 13 causes the partial area D2a of the selected display D2 to display images representing the integrated information. Thereafter, the remote instruction system 100 ends the process of FIG. 11.

The remote instruction program causes the processor 50a of the relay server 50 and the processor 10a of the remote instruction server 10 to function (operate) as the integrated information generation unit 53 and the display control unit 13 described above. The remote instruction program is stored in a non-transitory recording medium (storage medium) such as a ROM or a solid-state memory. Further, the remote instruction program may be provided to the relay server 50 which is a cloud server via communication such as a network.

As described above, according to the remote instruction system 100 and the remote instruction program, integrated information obtained by integrating a plurality of pieces of communication quality information is generated. One display D2 (target area) is selected from the displays D1, D2, and D3, and images of the bar graph 60 representing the integrated information are displayed on the selected display D2. Thus, the remote commander R can recognize the integrated information by looking at one display D2. Therefore, the communication quality information can be displayed to the remote commander R in a manner that is easy for the remote commander R to recognize, as compared with, for example, when the plurality of communication quality information is directly displayed on each of the displays D1, D2, and D3 without integrating the plurality of communication quality information.

A recommended speed which is the vehicle speed of the vehicle 2 corresponding to the communication quality information is generated as the integrated information, and images of the recommended speed display 70 representing the recommended speed are displayed on the display D2. As a result, the remote commander R recognizes the integrated information, so that the recommended speed corresponding to the communication quality information can be recognized.

Although the embodiments of the present disclosure have been described above, the present disclosure is not limited to the above-described embodiments.

In the above embodiment, the case where all of the vehicle transmission image data (detection data) of the vehicle 2 is transmitted from the vehicle 2 has been exemplified, and therefore, the surrounding environment images corresponding to all of the vehicle transmission image data are displayed on all of the displays D1, D2, and D3 for the remote commander R, but the present disclosure is not limited to this example. In the case where part of the detection data is sent from the vehicle, the display control unit 13 may select the target area from among the display areas in which the surrounding environment image corresponding to the part of the detection data is displayed. As used herein, “in the case where part of the detection data is sent from the vehicle” includes a case where the sensor including the detection data in the vehicle transmission image data among the plurality of sensors included in the external sensor 22 is determined by the above-described display information acquisition unit 34, or a case where a portion to be transmitted to the relay server 50 in the detection data of the external sensor 22 is extracted by the above-described display information acquisition unit 34. Further, “in the case where part of the detection data is sent from the vehicle” includes a case where part of the vehicle transmitted image data does not accidentally reach the relay servers 50 due to, for example, the radio wave strength and the communication quality of each of the networks N1a, N1b, and N1c.

For example, when the detection data corresponding to the display D2 out of the displays D1, D2, and D3 of FIG. 7 does not become the vehicle-transmitted image data, the surrounding environment image may be displayed only on the displays D1, D3. The display control unit 13 may select a target area from the displays D1, D3. In such a case, the remote commander R is more likely to view the display D1, D3, which is a display area in which the surrounding environment image corresponding to part of the detection data is displayed. Since the target area is selected from such a display area, the communication quality information can be displayed on the remote commander R in a manner that is easy for the remote commander R to recognize, as compared with, for example, when an image representing the integrated information is displayed on a display D2 on which the surrounding environment image is not displayed.

Even when all of the vehicle transmitted image data (detection data) of the vehicle 2 is transmitted from the vehicle 2, the surrounding environment image may not be displayed on all of the displays D1, D2, and D3. For example, surrounding environment images may be displayed only on the display D2. In short, the display control unit 13 may display the surrounding environment image in one or more of the plurality of display areas.

In the above embodiment, the recommended speed is generated as the integrated information, and the image representing the recommended speed is displayed in the target area, but the generation and display of the recommended speed may be omitted.

In the above embodiment, the vehicle 2 having the autonomous driving function is exemplified as the vehicle capable of executing the remote support, but the autonomous driving function is not essential. The vehicle may have a driving support function instead of the automatic driving function, or may have only a manual driving function. In short, the vehicle may be configured to be capable of executing remote support in response to a remote instruction from the remote commander.

In the above-described embodiment, the relay server 50 is interposed between the vehicle 2 and the remote instruction device 1, but the relay server 50 is not essential. The function of the relay server 50 may be included in the vehicle 2 or the remote instruction server 10. In this case, the functions (operations) of the relay information arbitration unit 52 and the integrated information generation unit 53 described above may be realized by executing a remote instruction program in the processor 10a of the remote instruction server 10 instead of the processor 50a of the relay server 50.

The function of the remote driving ECU 30 may be realized, for example, by controlling the actuator 25 of the vehicle 2 in response to a vehicle control demand from an Autonomous Driving Kit (ADK) connected to the vehicle 2 via a communication interface.

What is claimed is:

1. A remote instruction system configured to display a surrounding environment image to a remote commander based on detection data from an external sensor of a vehicle sent from the vehicle via a plurality of communication networks, the vehicle being configured to execute remote support according to a remote instruction from the remote commander, the remote instruction system comprising:
an integrated information generation unit configured to generate, based on communication quality information of each of the communication networks, integrated information of a plurality of pieces of the communication quality information; and
a display control unit configured to acquire display data of the surrounding environment image based on the detection data received from the vehicle and display the surrounding environment image in one or more of a plurality of display areas for the remote commander, wherein
the display control unit is configured to select one target area from the display areas and display an image representing the integrated information in the selected target area.

2. The remote instruction system according to claim 1, wherein the display control unit is configured to, in a case where part of the detection data is sent from the vehicle, select the target area from the display areas in which the surrounding environment image corresponding to the part of the detection data is displayed.

3. The remote instruction system according to claim 1, wherein
the integrated information generation unit is configured to generate a recommended speed as the integrated information, the recommended speed being a vehicle speed of the vehicle according to the communication quality information, and
the display control unit is configured to display an image representing the recommended speed in the target area.

4. A non-transitory storage medium storing a remote instruction program configured to cause a processor to operate to display a surrounding environment image to a remote commander based on detection data from an external sensor of a vehicle sent from the vehicle via a plurality of communication networks, the vehicle being configured to execute remote support according to a remote instruction from the remote commander, wherein
the remote instruction program is configured to cause the processor to operate as an integrated information generation unit and a display control unit, the integrated information generation unit being configured to generate, based on communication quality information of each of the communication networks, integrated information of a plurality of pieces of the communication quality information, and the display control unit being configured to acquire display data of the surrounding environment image based on the detection data received from the vehicle and display the surrounding environment image in one or more of a plurality of display areas for the remote commander, and
the remote instruction program is configured to cause the processor to operate in such a manner that the display control unit selects one target area from the display areas and displays an image representing the integrated information in the selected target area.
